(19) United States
(12) Patent Application Publication
(10) Pub. No.: US 2025/0231513 A1
(43) Pub. Date: Jul. 17, 2025

(54) IMAGE FORMING SYSTEM, CONVEYANCE SPEED CONTROL METHOD AND STORAGE MEDIUM

(71) Applicant: KONICA MINOLTA, INC., Tokyo (JP)

(72) Inventors: Hidenori MINE, Tokyo (JP); Yuta TACHIBANA, Toyokawa-shi (JP); Masato SAKURAI, Tokyo (JP); Kazumichi YOSHIDA, Tokyo (JP); Kouei CHO, Toyohashi-shi (JP); Kei KIYAMA, Tokyo (JP)

(73) Assignee: KONICA MINOLTA, INC., Tokyo (JP)

(21) Appl. No.: 19/002,164

(22) Filed: Dec. 26, 2024

(30) Foreign Application Priority Data
Jan. 12, 2024 (JP) 2024-002959

(51) Int. Cl. G03G 15/00; H04N 1/00

(52) U.S. Cl. CPC G03G 15/5029; G03G 15/6564; G03G 15/6579; H04N 1/00806; G03G 2215/00738; G03G 2215/00742; G03G 2215/00776

(57) ABSTRACT

An image forming system includes an image former that forms an image on a sheet, a reader that reads the image formed on the sheet by the image former, and a hardware processor that controls a conveyance speed of the sheet at the reader in accordance with a physical property value of the sheet.

### BACKGROUND OF THE INVENTION

### Technical Field

The present invention relates to an image forming system, a conveyance speed control method and a storage medium.

### Description of Related Art

Image forming apparatuses that form images on sheets have been known. Various types (properties) of sheets are used as sheets on which the image forming apparatuses form images. In order to generate a high-quality print product, it is necessary to adjust an image position on a sheet. Therefore, for example, a configuration is known in which a reference image formed on a sheet is read by a reading section and its result is fed back to an image forming section. According to this configuration, image positions on the front side and the back side of a sheet can be aligned.

When the reading section reads a reference image to be used for front-and-back position adjustment, highly accurate position detection is required. However, in the case of the conventional configuration, it is widely known that shock noise occurs when the reference image used for the front-and-back position adjustment is read. The shock noise occurs when a sheet enters conveyance roller(s) or conveyance roller(s) in the vicinity of the reading section. When height fluctuation or speed fluctuation of a sheet occurs due to the shock noise at the time of conveying the sheet to the reading section, adverse effects such as pitch unevenness and a magnification fluctuation occur in the read image. That is, occurrence of the shock noise affects the accuracy of the position detection by the reading section.

Then, Japanese Unexamined Patent Publication No. 2018-067813 discloses a configuration in which a reference image is formed at a position shifted from a place read by a reading section when shock noise occurs.

Further, Japanese Unexamined Patent Publication No. 2018-142845 discloses a configuration in which the distance between a reading position by a reading section and conveyance roller(s) is adjustable.

### SUMMARY OF THE INVENTION

However, in the configuration described in Japanese Unexamined Patent Publication No. 2018-067813, movable images are limited, and therefore there is a problem that use applications are limited.

Further, in the configuration described in Japanese Unexamined Patent Publication No. 2018-142845, a mechanism for moving the conveyance rollers is required, and therefore there is a problem that cost increases.

Further, in either of the configurations, shock noise may become large during reading by the reading section depending on the sheet type. In particular, in a case where a thick sheet or a sheet having a high stiffness enters the conveyance roller(s) or the conveyance roller(s) in the vicinity of the reading section, the shock noise may become large. Therefore, the influence of the shock noise may not be reduced only by adjusting the reading timing of the reference image and the position of the conveyance roller(s).

An object of the present invention is to provide an image forming system, a conveyance speed control method, and a non-transitory computer-readable storage medium storing a program, which are capable of generating high-quality print products without imposing a limitation on the formation position of a reference image and without increasing cost.

To achieve at least one of the abovementioned objects, according to an aspect of the present invention, an image forming system reflecting one aspect of the present invention includes:
an image former that forms an image on a sheet;
a reader that reads the image formed on the sheet by the image former; and
a hardware processor that controls a conveyance speed of the sheet at the reader in accordance with a physical property value of the sheet.

According to an aspect of the present invention, a conveyance speed control method reflecting one aspect of the present invention is for an image forming system including an image former that forms an image on a sheet and a reader that reads the image formed on the sheet by the image former, the conveyance speed control method including:
controlling a conveyance speed of the sheet at the reader in accordance with a physical property value of the sheet.

According to an aspect of the present invention, a non-transitory computer-readable storage medium reflecting one aspect of the present invention stores a program causing, of an image forming system including an image former that forms an image on a sheet and a reader that reads the image formed on the sheet by the image former, a computer to:
control a conveyance speed of the sheet at the reader in accordance with a physical property value of the sheet

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 illustrates a schematic configuration of an image forming system according to the present embodiment;

FIG. 2 is a functional block diagram illustrating a control structure of the image forming system according to the present embodiment.

FIG. 3 illustrates an example of a sheet conveyance speed table.

FIG. 4 illustrates an example of a reference image for position adjustment formed on a sheet;

FIG. 5 illustrates an example of configuration of an image reading section;

FIG. 6 is a flowchart illustrating an example of control of the image forming system according to the present embodiment; and

FIG. 7 illustrates a timing at which a conveyance speed of a sheet(s) is changed.

### DETAILED DESCRIPTION

Hereinafter, one or more embodiments of the present invention will be described in detail with reference to the drawings. However, the scope of the invention is not limited to the disclosed embodiments.

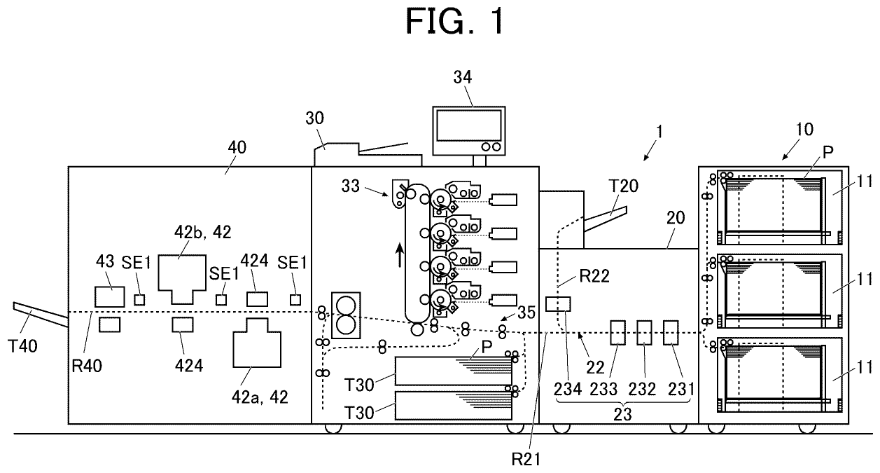

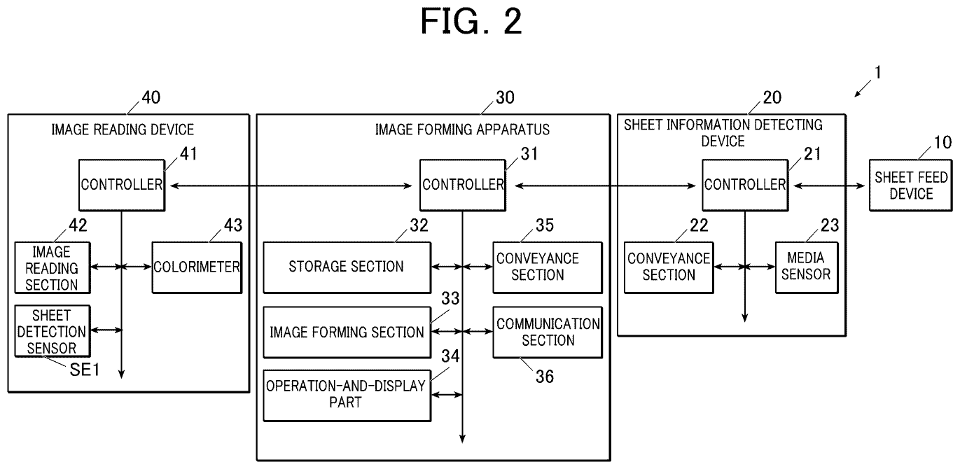

As illustrated in FIG. 1 and FIG. 2, an image forming system 1 according to the present embodiment includes a sheet feed device 10, a sheet information detecting device 20, an image forming apparatus 30, and an image reading device 40. In the image forming system 1, the sheet feed device 10, the sheet information detecting device 20, the image forming apparatus 30, and the image reading device 40 are connected in this order along a conveyance direction of sheets P.

The sheet feed device 10 includes a plurality of sheet feed trays 11 and a sheet feeder (not illustrated), and feeds sheets P stored in the sheet feed trays 11 to the sheet information detecting device 20. The sheet feeder includes, for example, a sheet feed roller, a separation roller, a sheet feed/separation rubber, a feed-out roller and the like. Each sheet feed tray 11 stores sheets P by type (sheet type, basis weight, sheet size, etc.) of the sheets P. The sheet feed device 10 conveys sheets P one by one from the top stored in each sheet feed tray 11 to the sheet information detecting device 20.

The sheet information detecting device 20 is connected to a subsequent stage of the sheet feed device 10. The sheet information detecting device 20 includes a controller 21, a conveyance section 22, and a media sensor 23.

The controller 21 includes a CPU, a ROM, a RAM, and the like, and integrally controls the operation of each component of the sheet information detecting device 20.

The conveyance section 22 includes a plurality of roller pairs. The conveyance section 22 conveys a sheet P conveyed from the sheet feed device 10 to the image forming apparatus 30 or a purge tray T20. The conveyance section 22 includes a stiffness detection path R22 that branches from a conveyance path R21 and leads to the purge tray T22. The conveyance path R21 leads to the image forming apparatus 30.

The media sensor 23 detects physical property values of the sheet P. The media sensor 23 includes a sheet thickness sensor 231, a moisture percentage sensor 232, a basis weight sensor 233, and a stiffness sensor 234. The sheet thickness sensor 231 detects the sheet thickness of the sheet P. The moisture percentage sensor 232 detects the moisture percentage of the sheet P. The basis weight sensor 233 detects the basis weight of the sheet P. The stiffness sensor 234 detects the stiffness of the sheet P.

The sheet thickness sensor 231, the moisture percentage sensor 232, and the basis weight sensor 233 are disposed on a conveyance path R21 that leads to the image forming apparatus 30.

The stiffness sensor 224 is disposed on a stiffness detection path R22 that leads to a purge tray T20 and in the vicinity of a branch portion from the conveyance path R21. The stiffness sensor 224 detects the stiffness of the sheet P by reading the force applied to the sheet P bent at the branch portion. The sheet P whose stiffness has been detected by the stiffness sensor 224 is ejected to the purge tray T20.

In the present embodiment, as illustrated in FIG. 1, the media sensor 23 is disposed on the upstream side of an image forming section 33 (image former) in a conveyance direction of the sheet P.

The image forming apparatus 30 is connected to the subsequent stage of the sheet information detecting device 20. The image forming apparatus 30 includes a controller 31 (hardware processor), a storage section 32, an image forming section 33 (image former), an operation-and-display part 34, a conveyance section 35, and a communication section 36. The image forming apparatus 30 forms an image on the sheet P conveyed from the sheet information detecting device 20.

The controller 31 includes a CPU and a memory, and controls the entire image forming apparatus 30. The CPU is a control circuit constituted by a multi-core processor or the like that executes control of each component described above and various kinds of arithmetic processing in accordance with programs. Each function of the image forming apparatus 30 is achieved by the CPU executing a corresponding program. The memory is a high-speed accessible main storage device that temporarily stores a program(s) and data as a work area. As the memory, for example, a DRAM, an SDRAM, an SRAM, or the like is adopted.

For example, the controller 31 controls the conveyance speed of the sheet P at a reader in accordance with the physical property values (stiffness, sheet thickness, moisture percentage, basis weight) of the sheet P. Specifically, the controller 31 controls the conveyance speed in accordance with the physical property values detected by the media sensor 23.

The storage section 32 is a large-capacity auxiliary storage device that stores various programs including an operating system and various types of data. As the storage, for example, a hard disk, a solid state drive, a flash memory, a ROM, or the like is adopted. The storage section 32 stores, for example, the stiffness of the sheet P detected by the stiffness sensor 224. Further, the storage section 32 stores a sheet conveyance speed table TA1. The sheet conveyance speed table TA1 is a table which shows correspondence between the physical property values of the sheet P and the conveyance speed of the sheet P at a reader.

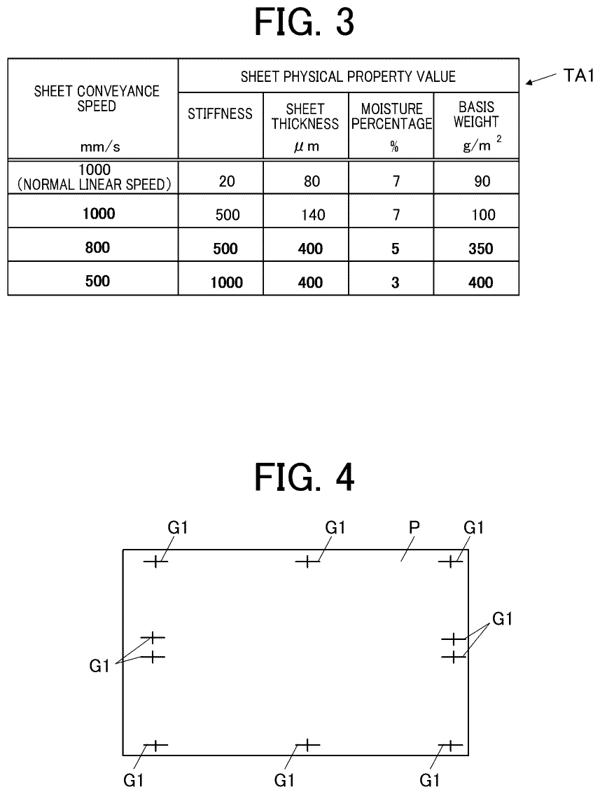

FIG. 3 illustrates an example of the sheet conveyance speed table TA1.

The controller 31 collates the physical property values (stiffness, sheet thickness, moisture percentage, basis weight) of the sheet P with the sheet conveyance speed table TA1 to determine the target value of the conveyance speed. In the example illustrated in FIG. 3, the normal (default) conveyance speed (normal linear speed) is “1000 mm/s”. For example, in a case where the stiffness is “500”, the sheet thickness is “140 μm”, the moisture percentage is “7%”, and the basis weight is “90 g/m²”, the target value of the conveyance speed is determined to be “1000 mm/s”. Further, in a case where the stiffness is “500”, the sheet thickness is “400 μm”, the moisture percentage is “5%”, and the basis weight is “350 g/m²”, the target value of the conveyance speed is determined to be “800 mm/s”. Further, in a case where the stiffness is “1000”, the sheet thickness is “400 μm”, the moisture percentage is “3%”, and the basis weight is “400 g/m²”, the target value of the conveyance speed is determined to be “500 mm/s”.

As illustrated in FIG. 3, the higher the stiffness, the slower the target value of the conveyance speed. Further, the thicker the sheet thickness, the slower the target value of the conveyance speed. Further, the lower the moisture percentage, the slower the target value of the conveyance speed. Further, the greater the basis weight, the slower the target value of the conveyance speed.

The controller 31 makes the conveyance speed slower as the stiffness detected by the stiffness sensor 224 is higher. Further, the controller 31 makes the conveyance speed slower as the sheet thickness detected by the sheet thickness sensor 231 is thicker. Further, the controller 31 makes the conveyance speed slower as the moisture percentage detected by the moisture percentage sensor 232 is lower. Further, the controller 31 makes the conveyance speed slower as the basis weight detected by the basis weight sensor 233 is greater.

The image forming section 33 forms an image on the sheet P conveyed from the sheet information detecting device 20 or the sheet P fed and conveyed from a sheet feed tray T30 of its own apparatus. The image forming section 33 forms an image on the sheet P using a known image forming process of an electrophotographic method including steps of, for example, charging, exposing, developing, transferring, and fixing.

The operation-and-display part 34 includes a touch screen, a numeric keypad, a start button, a stop button and the like, and is used for displaying various kinds of information and inputting various instructions. The user can set sheet information on the sheet P stored in each sheet feed tray T30 via the operation-and-display part 34. That is, the operation-and-display part 34 functions as a setter of the present invention for setting the sheet information on the sheet P to be fed by the sheet feed device 10. Note that the sheet information includes the basis weight and the size of the sheet P in addition to the sheet type of the sheet P.

The conveyance section 35 includes a plurality of conveyance rollers disposed on a conveyance path. First, the conveyance section 35 conveys the sheet P conveyed from the sheet information detecting device 20 or fed from the sheet feed tray T30 to the image forming section 33. Next, the conveyance section 35 ejects the sheet P on which an image has been formed by the image forming section 33 to the image reading device 40.

The communication section 36 transmits and receives various setting values, various types of information required for operation timing control, and the like to and from other devices.

The image reading device 40 is connected to the subsequent stage of the image forming apparatus 30, and includes a controller 41, an image reading section 42, a colorimeter 43, and a sheet detection sensor SE1.

The controller 41 includes a CPU, a ROM, a RAM, and the like, and integrally controls the operation of each component of the image reading device 40.

The image reading section 42 scans both sides of the sheet P on which images have been formed by the image forming section 33 to optically read the images on the both sides of the sheet P. That is, the image reading section 42 functions as a reader of the present invention. The read image(s) read and obtained by the image reading section 42 is output to the controller 31 of the image forming apparatus 30. The sheet P read by the image reading section 42 is ejected to a sheet ejection tray T40.

The controller 31 adjusts an image forming position on the sheet P in accordance with the reading result obtained by the image reading section 42 reading a reference image(s) G1 for position adjustment formed on the sheet P. That is, the controller 31 functions as an adjustment section of the present invention. FIG. 4 illustrates an example of the reference image G1 for position adjustment formed on the sheet P.

The image reading section 42 includes a back-side image reading section 42a and a front-side image reading section 42b.

The back-side image reading section 42a is provided under a conveyance path R40 and reads an image formed on the back side of the sheet P. The front-side image reading section 42b is provided above the conveyance path R40 and reads an image formed on the front side of the sheet P. The front-side image reading section 42b is provided on the downstream side of the back-side image reading section 42a in the conveyance direction of the sheet P. The back-side image reading section 42a and the front-side image reading section 42b are disposed at positions different from each other with a distance in between in the conveyance direction of the sheet P. Thus, both sides of the sheet P can be read in one pass. Therefore, the controller 31 can adjust the image forming positions on the front side and the back side of the sheet P.

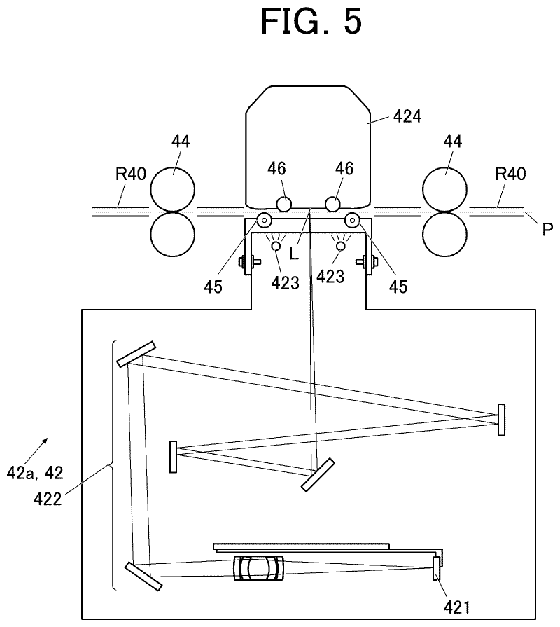

FIG. 5 illustrates an example of the configuration of the image reading section 42. The configuration of the back-side image reading section 42a will be described with reference to FIG. 5. Note that the front-side image reading section 42b has substantially the same configuration as the back-side image reading section 42a, and the description thereof will be omitted.

The back-side image reading section 42a includes a CCD 421, an optical system 422, and an LED light source 423.

The charge coupled device (CCD) 421 is an optical sensor that reads an image formed on the sheet P at a predetermined reading position L. The CCD 421 is a color line sensor capable of reading an area of the entire width in the width direction of the sheet P.

The optical system 422 includes a plurality of mirrors and a plurality of lenses, and guides an image at the reading position L to the CCD 421.

The LED (Light Emitting Diode) light source 423 is a light source that illuminates the reading position L.

With the above-described configuration, the back-side image reading section 42a can sequentially read images formed on sheets P over the entire width of the sheets P passing through the reading position L.

When the image reading is performed by the back-side image reading section 42a, the sheet P is conveyed by the plurality of conveyance rollers 44 provided on the conveyance path R40 such that the sheet P passes through the reading position L at a predetermined speed.

A calibration section 424 is provided above the back-side image reading section 42a so as to sandwich the conveyance path R40 in between.

The calibration section 424 includes a white reference plate for determining a correction value of shading correction performed at the time of reading an image. The white reference plate is provided at the reading position L, and the CCD 421 reads it at intervals at which no sheet P passes (e.g., between sheets P).

On the upper surface (surface close to the conveyance path R40) of the back-side image reading section 42a, first conveyance guide rollers 45 are provided. Each of the first conveyance guide rollers 45 is inserted through a rotation shaft that is perpendicular to the conveyance direction of the sheet P, and is rotatable around the rotation shaft.

On the lower surface (surface closer to the conveyance path R40) of the calibration section 424, second conveyance guide rollers 46 are provided. Each of the second conveyance guide rollers 46 is inserted through a rotation shaft that is perpendicular to the conveyance direction of the sheet P, and is rotatable around the rotation shaft.

The colorimeter 43 is disposed on the downstream side of the front-side image reading section 42b in the conveyance direction of the sheet P. The colorimeter 43 spectroscopically measures the color of each color patch of a patch image formed on the sheet P by the image forming section 33, and obtains colorimetric data. That is, the colorimeter 43 functions as a reader of the present invention which reads the image formed on the sheet P by the image forming section 33.

Although not illustrated, a plurality of conveyance rollers, a calibration section, conveyance guide rollers, and the like are provided in the vicinity of the colorimeter 43, similarly to the image reading section 42. Therefore, shock noise occurs during reading by the colorimeter 43 too.

The sheet detection sensor SE1 is provided on the upstream side of the reading sections in the conveyance direction of the sheet P. The reading sections are the front-side image reading section 42b, the back-side image reading section 42a, and the colorimeter 43. The sheet detection sensor SE1 is, for example, an optical sensor that optically detects the passing sheet P. That is, the sheet detection sensor SE1 can detect that the leading end of the sheet P, which passes there, has reached.

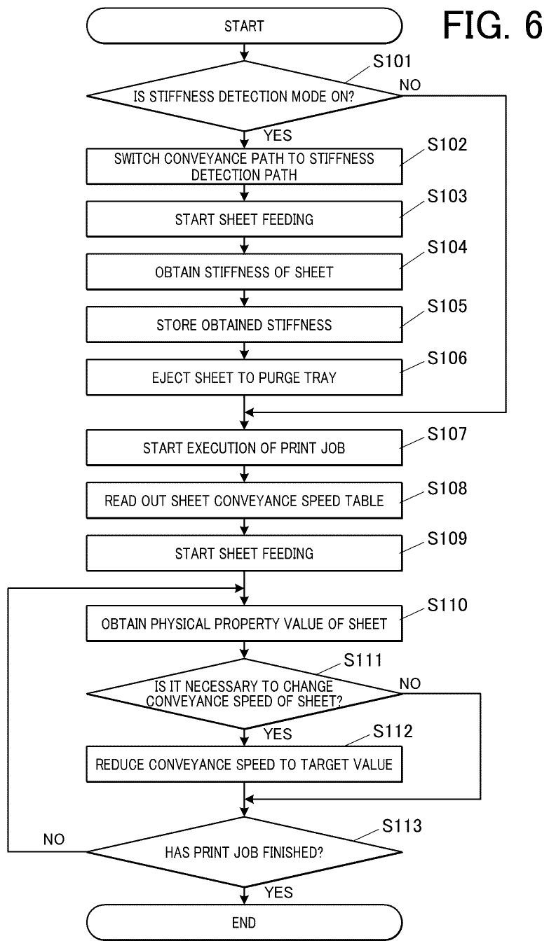

Next, control of the image forming system 1 according to the present embodiment will be described with reference to the flowchart of FIG. 6. The control in FIG. 6 is started with obtainment of a print job by the controller 31 of the image forming apparatus 30 from an external apparatus or the like via the communication section 36 as a trigger. Note that the controller 31 controls the sheet feed device 10. Further, the controller 31 controls the sheet information detecting device 20 via the controller 21. Further, the controller 31 controls the image reading device 40 via the controller 41.

In the present embodiment, the sheet thickness sensor 231, the moisture percentage sensor 232, and the basis weight sensor 233 are disposed on the conveyance path R21 that leads to the image forming apparatus 30. Therefore, it is possible to detect the physical property values of the sheet P during execution of the print job. Therefore, the conveyance speed at the reader(s) can be controlled in real time for each sheet P whose physical property values have been detected.

The stiffness sensor 224 detects the stiffness of the sheet P by reading the force applied to the bent sheet P. That is, the sheet P the stiffness of which has been detected by the stiffness sensor 224 is not usable as a commodity, and therefore is ejected to the purge tray T20. Therefore, the physical property values of the sheet P cannot be detected during the execution of the print job. Therefore, it is necessary to detect the stiffness of the sheet P before execution of a print job and control the conveyance speed at the reader using the value during execution of the print job. In the present embodiment, the controller 31 causes the stiffness sensor 234 to detect the stiffness of the sheet P before execution of a print job.

Hereinafter, the control of the image forming system 1 will be described with reference to FIG. 6.

First, the controller 31 determines whether a stiffness detection mode is ON (Step S101). The stiffness detection mode is a mode in which the stiffness of the sheet P is detected before execution of a print job and the detected stiffness is used for conveyance speed control at the reader during execution of the print job.

When the controller 31 determines that the stiffness detection mode is ON (Step S101: YES), the controller 31 proceeds to the next step S102.

On the other hand, when the controller 31 determines that the stiffness detection mode is not ON (is OFF) (Step S101: NO), the controller 31 proceeds to Step S107.

Next, the controller 31 switches the conveyance path of the sheet P from the conveyance path R21 to the stiffness detection path R22 (Step S102).

Next, the controller 31 controls the sheet feed device 10 to start feeding of a sheet P (Step S103).

Next, the controller 31 obtains the stiffness of the sheet P detected by the stiffness sensor 224 (Step S104).

Next, the controller 31 stores the stiffness of the sheet P obtained in Step S104 in the storage section 32 (Step S105).

Next, the controller 31 ejects the sheet P whose stiffness has been detected by the stiffness sensor 224 to the purge tray T20 (Step S106).

Next, the controller 31 starts execution of a print job (Step S107).

Next, the controller 31 reads out the sheet conveyance speed table TA1 stored in the storage section 32 (Step S108).

Next, the controller 31 controls the sheet feed device 10 to start feeding of a sheet P (Step S109).

Next, the controller 31 obtains the physical property values of the sheet P detected by the media sensor 23 disposed on the conveyance path R21 (Step S110). Specifically, the sheet thickness, the basis weight, and the moisture percentage detected by the sheet thickness sensor 231, the moisture percentage sensor 232, and the basis weight sensor 233, respectively, are obtained.

Next, the controller 31 determines whether it is necessary to change the conveyance speed of the sheet P at the reader (Step S111). To be specific, first, the controller 31 collates the stiffness obtained in Step S104 and the physical property values obtained in Step S110 with the sheet conveyance speed table TA1, and extracts (determines) the target value of the conveyance speed. Next, the controller 31 compares the current conveyance speed with the extracted target value to determine whether it is necessary to change the conveyance speed.

If the controller 31 determines that the conveyance speed needs to be changed (Step S111: YES), the controller 31 proceeds to the next Step S112.

If the controller 31 determines that the conveyance speed does not need to be changed (Step S111: NO), the controller 31 proceeds to Step S113.

In Step S112, the controller 31 reduces the conveyance speed of the sheet P at the reader to the target value. Thereafter, the process proceeds to Step S113.

As described above, the controller 31 controls the conveyance speed of the sheet P during execution of the print job, according to at least one of the physical property values of the sheet P detected by the media sensor 23 disposed on the conveyance path R21. Specifically, the conveyance speed of the sheet P is controlled during execution of the print job in accordance with at least one of the sheet thickness, the moisture content, and the basis weight of the sheet P.

In the present embodiment, the controller 31 controls the conveyance speed of the sheet P before the reference image for image adjustment formed on the sheet P enters the reader. Alternatively, the controller 31 controls the conveyance speed of the sheet P before the leading end of the sheet P enters the reader.

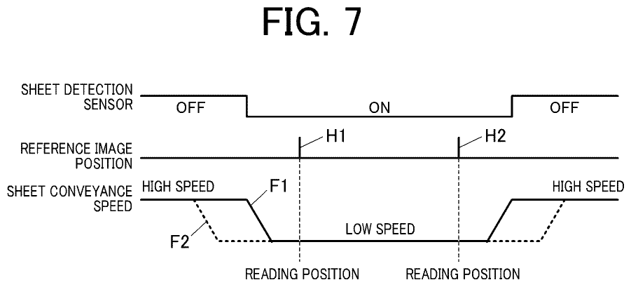

FIG. 7 is a n illustration for explaining the timing of changing the conveyance speed of the sheet P. A solid line F1 indicates an example of the conveyance speed in a case where the conveyance speed is controlled before the reference image enters the reader. A broken line F2 indicates an example of the conveyance speed in a case where the conveyance speed is controlled before the leading end of the sheet P enters the reader. In the example illustrated in FIG. 7, the deceleration time is relatively shorter in the solid line F1 than in the broken line F2.

A state where the sheet detection sensor SE1 is ON indicates that the sheet detection sensor SE1 provided on the upstream side of the reader in the conveyance direction is detecting the passing sheet P. That is, the timing at which the sheet detection sensor SE1 switches from OFF to ON indicates that the leading end of the sheet P is being detected. In the example indicated by the broken line F2, the conveyance speed becomes slow before the timing at which the sheet detection sensor SE1 switches from OFF to ON.

A reference image position is a position of a reference image for image adjustment formed on the sheet P. The “H1” at the reference image position indicates that the reference image formed at or close to the leading end of the sheet P has reached the reading position of the reader. The “H2” at the reference image position indicates that the reference image formed at or close to the trailing end of the sheet P has reached the reading position of the reader. In the example indicated by the solid line F1, the conveyance speed becomes slow before the timing at which the reference image formed at or close to the leading end of the sheet P reaches the reading position (enters the reader).

In the case where the conveyance speed is controlled before the reference image enters the reader, it is possible to relatively shorten the deceleration time, and thus it is possible to improve the productivity of image printing.

On the other hand, in the case where the conveyance speed is controlled before the leading end of the sheet P enters the reader, the deceleration can be started relatively early, so that the image can be read in a state in which the posture of the sheet is stable.

In Step S113, the controller 31 determines whether the print job has finished.

If the controller 31 determines that the print job has finished (Step S113: YES), the controller 31 ends the process.

If the controller 31 determines that the print job has not finished (Step S113: NO), the controller 31 proceeds to Step S110. Thereafter, the process is repeated until the print job finishes. That is, the conveyance speed can be controlled in real time for each sheet P whose physical property values (sheet thickness, basis weight, and moisture percentage) have been obtained.

In the present embodiment, the controller 31 controls the conveyance speed at the time when the reader reads the reference image for image adjustment formed on the sheet P. The reference image for image adjustment includes a patch image read by the colorimeter 43 in addition to the reference image G1 for position adjustment read by the image reading section 42.

As described above, the image forming system 1 according to the present embodiment includes the image forming section 33, the reader (the image reading section 42 and the colorimeter 43), and the controller 31. The image forming section 33 forms an image on a sheet. The reader reads the image formed on the sheet by the image forming section 33. The controller 31 controls the conveyance speed of the sheet at the reader according to the physical property values of the sheet.

Therefore, according to the image forming system 1 of the present embodiment, the influence of shock noise can be reduced. In particular, it is possible to reduce the influence of the shock noise on the sheet whose reading accuracy decreases due to the influence of the shock noise. With this configuration, it is possible to sufficiently ensure the accuracy of reading by the reader.

In addition, it is possible to generate high-quality print products without reducing productivity in the case of normal sheets which are not affected by shock noise.

In addition, since there is no limitation on the position at which the reference image is formed, various reference images can be accurately read.

Further, since a mechanism for moving the conveyance rollers is not required, it is possible to sufficiently ensure the reading accuracy without increasing the cost.

Thus, it is possible to generate high-quality print products without imposing a limitation on the formation position of a reference image and without increasing cost.

The image forming system 1 further includes the media sensor 23 that detects the physical property values. The controller 31 controls the conveyance speed according to the physical property values detected by the media sensor 23.

Therefore, it is possible to control the conveyance speed by detecting the physical property values of the sheet that is actually conveyed. Therefore, it is possible to more accurately reduce the influence of the shock noise.

Further, the media sensor 23 is disposed on the upstream side of the image forming section 33 in the conveyance direction of the sheet.

Therefore, the physical property values of the sheet can be detected before the image is read by the reader. Therefore, the image formed on the sheet whose physical property values have been detected can be accurately read in-line.

The image forming apparatus further includes an adjustment section (controller 31) that adjusts an image forming position on a sheet in accordance with a reading result obtained by the reader reading a reference image for position adjustment formed on the sheet. The adjustment section adjusts image forming positions on the front side and the back side of the sheet.

Therefore, the image forming positions on the front side and the back side of the sheet can be accurately adjusted. Therefore, the quality of a print product can be improved.

Further, the controller 31 controls the conveyance speed when the reader reads the reference image for image adjustment formed on the sheet.

Therefore, it is possible to sufficiently secure the accuracy of reading by the reader. Therefore, high-quality print products can be generated.

Further, the controller 31 makes the conveyance speed slower as the stiffness detected by the stiffness sensor 234 is higher. The controller 31 makes the conveyance speed slower as the sheet thickness detected by the sheet thickness sensor 231 is thicker. The controller 31 makes the conveyance speed slower as the moisture percentage detected by the moisture percentage sensor 232 is lower. The controller 31 makes the conveyance speed slower as the basis weight detected by the basis weight sensor 233 is greater.

Therefore, it is possible to reduce the influence of the shock noise on the sheet whose reading accuracy decreases due to the influence of the shock noise. With this configuration, it is possible to sufficiently ensure the accuracy of reading by the reader. Therefore, high-quality print products can be generated.

Further, the controller 31 causes the stiffness sensor 234 to detect stiffness before execution of a print job.

Therefore, the print job can be executed after the sheet bent at the time of detecting the stiffness is ejected to the purge tray T20. Therefore, it is possible to prevent a waste sheet from being mixed with a print product.

Further, the controller 31 controls the conveyance speed during the execution of the print job according to at least one of the sheet thickness detected by the sheet thickness sensor 231, the moisture percentage detected by the moisture percentage sensor 232, and the basis weight detected by the basis weight sensor 233.

Therefore, it is possible to accurately read, in-line, the image formed on the sheet whose physical property values have been detected during execution of the print job. Therefore, the productivity of image printing can be improved.

Further, the controller 31 controls the conveyance speed before the reference image for image adjustment formed on the sheet enters the reader.

Therefore, it is possible to relatively shorten the deceleration time of the conveyance speed. Therefore, the productivity of image printing can be improved.

Further, the controller 31 controls the conveyance speed before the leading end of the sheet enters the reader.

Therefore, it is possible to relatively quickly start the deceleration of the conveyance speed. Therefore, it is possible to read an image in the state in which the sheet posture is stable.

Although the present invention has been described in detail based on an embodiment, the present invention is not limited to the above-described embodiment, and can be modified without departing from the scope of the present invention.

For example, in the above embodiment, the physical property values detected by the media sensor 23 are obtained, but the present invention is not limited thereto. The physical property values may be obtained based on sheet information set by the user via the operation-and-display part 34. That is, the controller 31 obtains the physical property values (stiffness, sheet thickness, moisture percentage, and basis weight) of the sheet P on the basis of the sheet information such as the sheet type, basis weight, and size of the sheet P. In this case, the controller 31 functions as an obtaining section of the present invention. Then, the controller 31 controls the conveyance speed of the sheet P at the reader according to the obtained physical property values.

The above embodiment illustrates the configuration in which the stiffness sensor 234, the sheet thickness sensor 231, the moisture percentage sensor 232, and the basis weight sensor 233 are provided as the media sensor 23, but the invention is not limited thereto. The media sensor 23 may include at least one of the stiffness sensor 234, the sheet thickness sensor 231, the moisture percentage sensor 232, and the basis weight sensor 233.

Further, in the above embodiment, the media sensor 23 is disposed on the upstream side of the image forming section 33 in the conveyance direction of the sheet P, but the invention is not limited thereto. For example, the media sensor 23 may be disposed on the downstream side of the image forming section 33 in the conveyance direction of the sheet P but on the upstream side of the image reading section 42 in the conveyance direction of the sheet P. That is, the sheet information detecting device 20 may be disposed between the image forming apparatus 30 and the image reading device 40.

By disposing the sheet information detecting device 20 between the image forming apparatus 30 and the image reading device 40, it is possible to control the conveyance speed of the sheet based on the physical property values of the sheet P with an image(s) formed. Thus, the influence of the shock noise can be further reduced. Therefore, the accuracy of reading by the reader can be further improved.

Besides, the detailed configuration/component of each device/apparatus and the detailed operation of each device/apparatus constituting the image forming system can be appropriately modified without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2024-002959, filed on Jan. 12, 2024, including description, claims, drawings and abstract is incorporated herein by reference.

What is claimed is:

1. An image forming system comprising:
an image former that forms an image on a sheet;
a reader that reads the image formed on the sheet by the image former; and
a hardware processor that controls a conveyance speed of the sheet at the reader in accordance with a physical property value of the sheet.

2. The image forming system according to claim 1, further comprising a media sensor that detects the physical property value, wherein the hardware processor controls the conveyance speed in accordance with the physical property value detected by the media sensor.

3. The image forming system according to claim 2, wherein the media sensor includes a stiffness sensor that detects a stiffness of the sheet, a sheet thickness sensor that detects a sheet thickness of the sheet, a moisture percentage sensor that detects a moisture percentage of the sheet, and/or a basis weight sensor that detects a basis weight of the sheet.

4. The image forming system according to claim 2, wherein the media sensor is disposed on an upstream side of the image former in a conveyance direction of the sheet.

5. The image forming system according to claim 2, wherein the media sensor is disposed on a downstream side of the image former in a conveyance direction of the sheet but on an upstream side of the reader in the conveyance direction.

6. The image forming system according to claim 1, wherein the hardware processor adjusts an image forming position on the sheet in accordance with a reading result obtained by the reader reading a reference image for position adjustment formed on the sheet.

7. The image forming system according to claim 6, wherein the hardware processor adjusts image forming positions, each of which is the image forming position, on a front side and a back side of the sheet.

8. The image forming system according to claim 1, wherein the hardware processor controls the conveyance speed when the reader reads a reference image for image adjustment formed on the sheet.

9. The image forming system according to claim 1, wherein the hardware processor
obtains the physical property value based on sheet information set by a user through a setter, and
controls the conveyance speed in accordance with the obtained physical property value.

10. The image forming system according to claim 3, wherein the hardware processor makes the conveyance speed slower as the stiffness detected by the stiffness sensor is higher.

11. The image forming system according to claim 3, wherein the hardware processor makes the conveyance speed slower as the sheet thickness detected by the sheet thickness sensor is thicker.

12. The image forming system according to claim 3, wherein the hardware processor makes the conveyance speed slower as the moisture percentage detected by the moisture percentage sensor is lower.

13. The image forming system according to claim 3, wherein the hardware processor makes the conveyance speed slower as the basis weight detected by the basis weight sensor is greater.

14. The image forming system according to claim 2,
wherein the media sensor includes a stiffness sensor that detects a stiffness of the sheet, and
wherein the hardware processor causes the stiffness sensor to detect the stiffness before executing a print job.

15. The image forming system according to claim 2,
wherein the media sensor includes a sheet thickness sensor that detects a sheet thickness of the sheet, a moisture percentage sensor that detects a moisture percentage of the sheet, and a basis weight sensor that detects a basis weight of the sheet, and
wherein the hardware processor controls the conveyance speed while executing a print job in accordance with the sheet thickness detected by the sheet thickness sensor, the moisture percentage detected by the moisture percentage sensor, and/or the basis weight detected by the basis weight sensor.

16. The image forming system according to claim 1, wherein the hardware processor controls the conveyance speed before a reference image for image adjustment formed on the sheet enters the reader.

17. The image forming system according to claim 1, wherein the hardware processor controls the conveyance speed before a leading end of the sheet enters the reader.

18. A conveyance speed control method for an image forming system including an image former that forms an image on a sheet and a reader that reads the image formed on the sheet by the image former, the conveyance speed control method comprising:
controlling a conveyance speed of the sheet at the reader in accordance with a physical property value of the sheet.

19. A non-transitory computer-readable storage medium storing a program causing, of an image forming system including an image former that forms an image on a sheet and a reader that reads the image formed on the sheet by the image former, a computer to:
control a conveyance speed of the sheet at the reader in accordance with a physical property value of the sheet.
